(19) United States
(12) Patent Application Publication
(10) Pub. No.: US 2011/0034155 A1
(43) Pub. Date: Feb. 10, 2011

(54) MOBILE TERMINAL, SETTLEMENT APPARATUS AND DISPLAY METHOD

(75) Inventor: Shunichiro Kamamoto, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/850,846

(22) Filed: Aug. 5, 2010

(30) Foreign Application Priority Data
Aug. 10, 2009 (JP) 2009-185792

(51) Int. Cl. H04M 3/42; H04B 1/38

(52) U.S. Cl. 455/414.1; 455/566

(57) ABSTRACT

A mobile terminal of an embodiment includes a communication section, a display section and a display unit. The communication section receives accounting information from a settlement apparatus to transmit the accounting information relating to a transaction. The display unit displays a receipt display indicating the accounting information on the display section for a specified time, and erases the receipt display when the specified time passes.

### CROSS-REFERENCE TO RELATED APPLICATIONS

This application is based upon and claims the benefit of priority from the prior Japanese Patent Application No. 2009-185792, Aug. 10, 2009 the entire contents of which are incorporated herein by reference.

### FIELD

Embodiments described herein relate generally to a mobile terminal, a settlement apparatus and a display method.

### BACKGROUND

In recent years, electronic settlement with electronic money is performed as settlement of a transaction in a retail store or the like. In such electronic settlement, near-distance wireless communication is performed between an IC card mounted in a mobile telephone terminal of a customer and a settlement apparatus provided in the store.

Besides, it is proposed that a receipt which is hitherto provided as a paper medium is converted into electronic information and is provided to a customer. For example, JP-A-2007-148792 (hereinafter referred to as document 1) discloses a technique in which accounting information is stored in a server, and the accounting information is enabled to be browsed from a mobile telephone terminal.

### BRIEF DESCRIPTION OF THE DRAWINGS

FIG. 1 is a structural view showing an electronic receipt system of an embodiment.

FIG. 2 is a block diagram showing a structure of a mobile telephone terminal of an embodiment.

FIG. 3 is a block diagram showing a structure of a POS terminal of an embodiment.

FIG. 4 is a sequence view showing an accounting process of an embodiment.

FIG. 5 is a view showing an example of a display screen of a mobile telephone terminal of an embodiment.

FIG. 6 is a view showing an example of a receipt display of the mobile telephone terminal of an embodiment.

### DETAILED DESCRIPTION

In the technique of the document 1, a customer must operate the mobile telephone terminal to access the server in order to browse the accounting information, and it takes much time to browse the accounting information.

According to embodiments, accounting information is enabled to be easily seen by a terminal carried by a customer.

A mobile terminal according to an embodiment includes a communication section, a display section, and a display unit. The communication section receives accounting information from a settlement apparatus to transmit the accounting information relating to a transaction. The display unit displays a receipt display indicating the accounting information on the display section for a specified time, and erases the receipt display when the specified time passes.

A settlement apparatus according to another embodiment includes a settlement unit, an accounting information transmission unit, and a notification unit. The settlement unit performs data communication with a mobile terminal, and performs electronic settlement of a transaction to the mobile terminal. After the electronic settlement is completed, the accounting information transmission unit transmits accounting information relating to the electronic settlement to the mobile terminal. After receiving reception completion information, which indicates reception of the accounting information, from the mobile terminal, the notification unit notifies that the electronic settlement is completed.

A display method according to still another embodiment is a display method executed in a mobile terminal including a communication section to receive accounting information from a settlement apparatus to transmit the accounting information of a transaction, and a display section. The display method includes displaying a receipt display indicating the accounting information on the display section for a specified time, and erasing the receipt display when the specified time passes.

Hereinafter, a mobile terminal, a settlement apparatus and a display method according to embodiments will be described in detail with reference to the accompanying drawings.

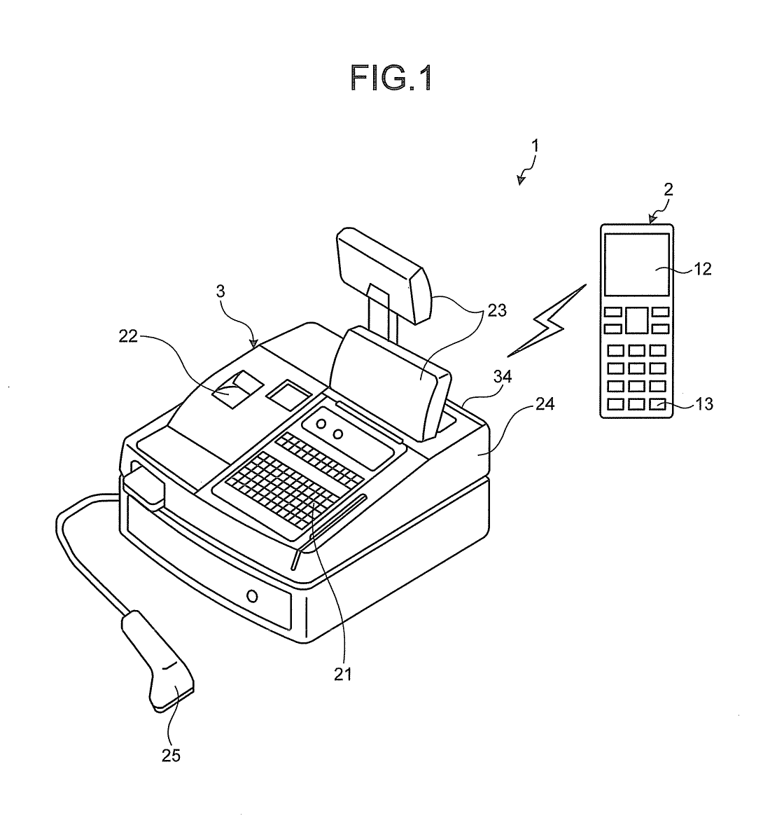

FIG. 1 is a structural view showing an electronic receipt system according to an embodiment. As shown in FIG. 1, an electronic receipt system 1 includes a mobile telephone terminal 2 as an example of a terminal carried by a customer, and a POS (Point of Sales) terminal 3 as an example of a settlement apparatus installed in a store. In the electronic receipt system 1, the mobile telephone terminal 2 and the POS terminal 3 performs electronic settlement as settlement of a transaction by using near-distance wireless communication. Incidentally, the POS terminal 3 can perform cash settlement.

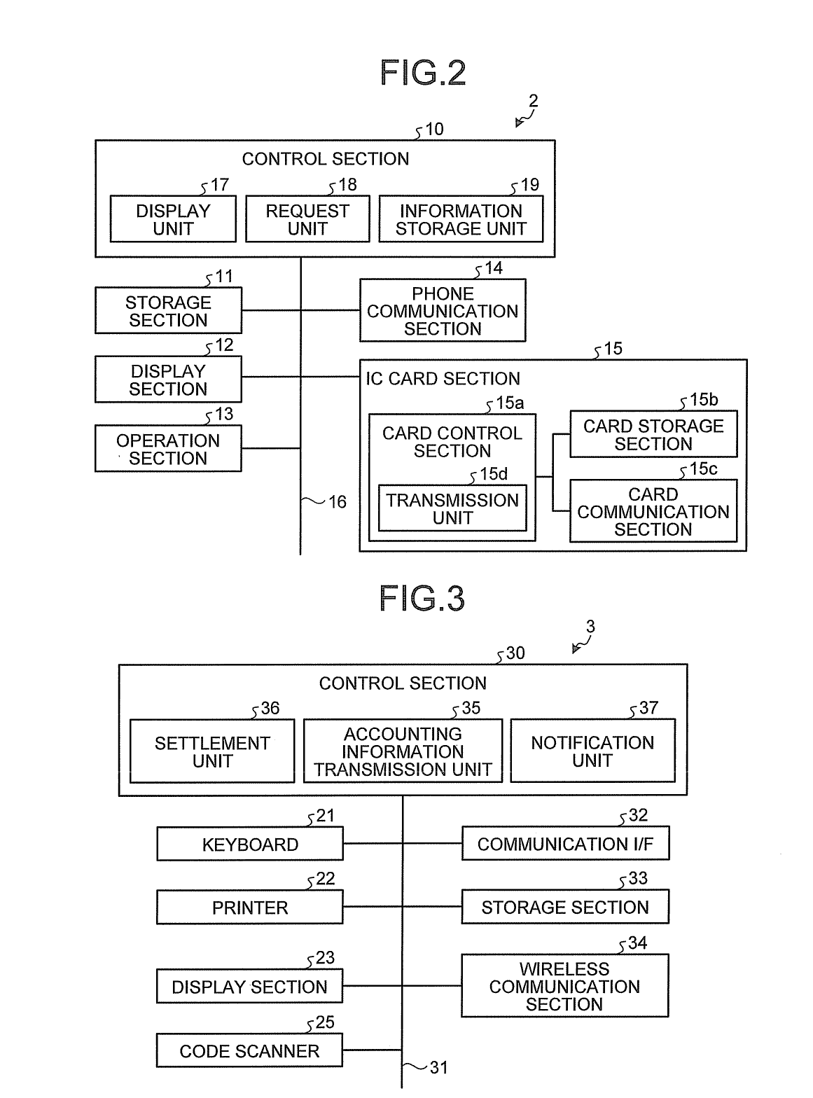

FIG. 2 is a block diagram showing a structure of the mobile telephone terminal 2. As shown in FIG. 2, the mobile telephone terminal 2 includes a control section 10, a nonvolatile storage section 11 to store information, a display section 12, an operation section 13, a telephone communication section 14, and an IC (Integrated Circuit) card section 15 as a payment unit. The control section 10 is connected with the storage section 11, the display section 12, the operation section 13, the telephone communication section 14 and the IC card section 15 through a bus 16.

The control section 10 is a computer including a CPU (Central Processing Unit) to concentrically control various arithmetic operations and the respective sections of the mobile telephone terminal 2, a ROM (Read Only Memory) to store various programs and various data, a RAM (Random Access Memory) to temporarily store various programs and to rewritably store various data, a VRAM (Video Random Access Memory), and a clock section to clock the present date and time.

The display section 12 is, for example, an LCD (Liquid Crystal Display). The operation section 13 is, for example, a keyboard having various operation keys. The telephone communication section 14 has a communication function, an internet mail function and the like.

The IC card section 15 includes a non-contact type IC card. The IC card section 15 includes a card control section 15a, a nonvolatile card storage section 15b to store information, and a card communication section 15c as a communication section. The IC card section 15 performs data communication (wireless communication) with the POS terminal 3 through the card communication section 15c, and performs the electronic settlement of the transaction to the POS terminal 3.

The card control section 15a is a computer including a CPU (Central Processing Unit) to concentrically control various arithmetic operations and the respective sections of the mobile telephone terminal 2, a ROM (Read Only Memory) to store various programs and various data, a RAM (Random Access Memory) to temporarily store various programs and to rewritably store various data, and a clock section to clock the present date and time. The card control section 15a is connected with the card storage section 15b and the card communication section 15c through a bus.

The card storage section 15b stores electronic settlement information relating to the electronic settlement. In this embodiment, the electronic settlement information includes the balance of prepaid type electronic money, customer identification information and the like.

The card communication section 15c includes an antenna, and performs near-distance wireless communication with an after-mentioned wireless communication section 34 of the POS terminal 3. This wireless communication is performed using, for example, an electric wave for near-distance wireless communication used in RFID (Radio Frequency Identification).

A program executed in the control section 10 of the mobile telephone terminal 2 having the above structure causes the control section 10 to perform functions as a display unit 17, a request unit 18 and an information storage unit 19. At that time, the CPU of the control section 10 reads the program from the storage section 11 and executes it.

Besides, a program executed in the card control section 15a of the mobile telephone terminal 2 having the above structure causes the card control section 15a to perform a function as a transmission unit 15d. At that time, the CPU of the card control section 15a reads the program from the ROM of the card control section 15a and executes it.

As shown in FIG. 1, the POS terminal 3 includes a body 24 provided with a keyboard 21, a printer 22, a display section 23 and the wireless communication section 34. The body 24 is connected with a code scanner 25 to optically read a commodity code attached to a commodity.

The keyboard 21 includes various operation keys by which a casher performs an operation input. The operation keys include, for example, a numeric key to input numerical values, a subtotal key to instruct total output of commodities for which sales registration in the transaction is performed, an electronic settlement key by which payment of the transaction is performed by electronic money, and a cash settlement key by which payment of the transaction is performed by cash. The electronic settlement key or the cash settlement key functions as a closing key to announce the closing of the transaction.

The printer 22 is a receipt printer which issues a paper receipt printed with accounting information relating to a transaction when cash settlement is performed.

FIG. 3 is a block diagram showing a structure of the POS terminal 3. As shown in FIG. 3, the POS terminal 3 includes a control section 30 to concentrically control various arithmetic operations and the respective sections of the POS terminal 3. The control section 30 is a computer including a CPU, a ROM to store various programs and various data, a RAM to temporarily store various programs and to rewritably store various data, and a clock section to clock the present date and time. The control section 30 is connected with a communication interface (communication I/F in the drawing) 32 through a bus 31, and the control section 30 can communicate with an external apparatus (not shown) through the communication interface 32. Besides, the control section 30 is connected with a storage section 33 to store information and the wireless communication section 34 in addition to the keyboard 21, the printer 22, the display section 23, and the code scanner 25 through the bus 31. By this, the control section 30 can control the respective sections, and signals from the keyboard 21, the code scanner 25 and the wireless communication section 34 can be inputted to the control section 30.

The wireless communication section 34 includes a not-shown antenna, and executes near-distance wireless communication with the card communication section 15c of the mobile telephone terminal 2. The wireless communication is performed using, for example, the electric wave for near-distance wireless communication used in RFID as described above. Besides, the wireless communication section 34 includes a speaker (not shown) as a notification device. The wireless communication section 34 is provided on the back part of the body 24.

The storage section 33 includes, for example, a hard disk drive, and stores a commodity master file to store commodity information and a sales file to store sales data in addition to a program to operate the CPU of the control section 30. The commodity master file stores a commodity name, unit price, and certificate issue necessity-unnecessity information which are correlated with a commodity code.

Here, the program executed in the POS terminal 3 causes the control section 30 to perform functions as an accounting information transmission unit 35, a settlement unit 36, an accounting information transmission unit 35, and a notification unit 37. At that time, the CPU of the control section 30 reads the program from the storage section 33, and executes it.

The settlement unit 36 performs data communication with the mobile telephone terminal 2, and performs electronic settlement of a transaction to the mobile telephone terminal 2. The accounting information transmission unit 35 generates accounting information relating to a transaction, and transmits the accounting information to the mobile telephone terminal 2. Particularly, after electronic settlement is completed, the accounting information transmission unit 35 transmits the accounting information relating to the electronic settlement to the mobile telephone terminal 2. After receiving reception completion information, which indicates that the accounting information is received, from the mobile telephone terminal 2, the notification unit 37 notifies that the electronic settlement is completed by using the speaker as the notification device.

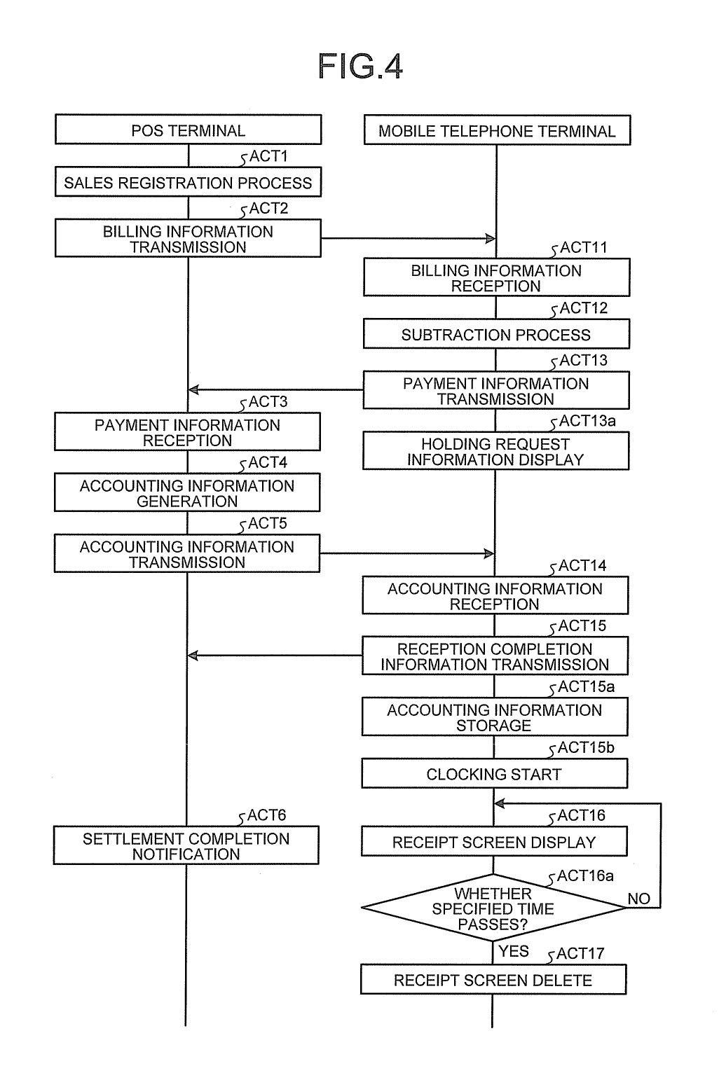

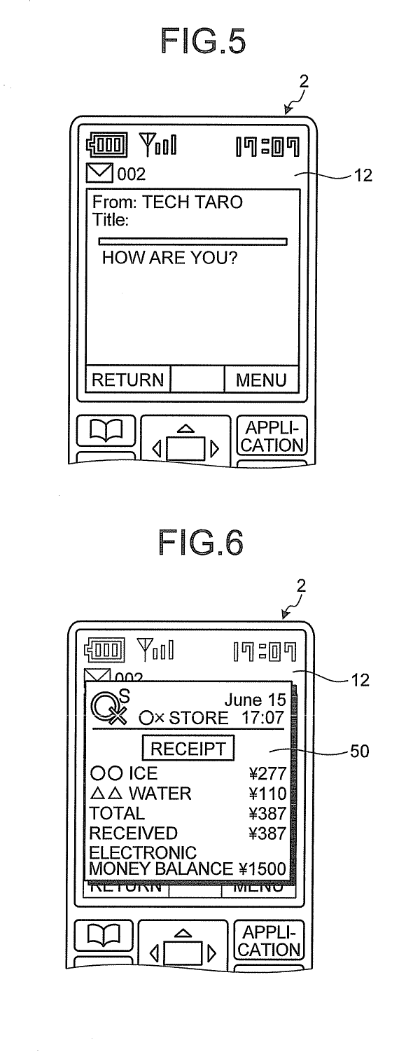

Next, an example of an accounting process executed by the mobile telephone terminal 2 and the POS terminal 3 will be described. Here, FIG. 4 is a sequence view showing the accounting process, FIG. 5 is a view showing an example of a display screen of the mobile terminal, and FIG. 6 is a view showing an example of a receipt display of the mobile terminal.

In the accounting process, first, the control section 30 of the POS terminal 3 performs a sales registration process of a commodity (Act 1). Particularly, with respect to a commodity specified by a commodity code included in data of a barcode read by the code scanner 25, the CPU of the control section 30 of the POS terminal 3 reads commodity data, such as unit price, from the commodity master file. The CPU of the control section 30 of the POS terminal 3 generates sales data based on the read commodity data (commodity name, unit prices), and performs selling registration of the commodity by storing the sales data in the sales file. The CPU of the control section 30 of the POS terminal 3 calculates the sales total amount based on the sales data and stores it in the sales file.

When the electronic settlement is announced by the electronic settlement key in the POS terminal 3, the control section 30 of the POS terminal 3 operates as the settlement unit 36, and transmits billing information including billing amount (total amount of commodities) of the sales registered commodities to the mobile telephone terminal 2 by the wireless communication section 34 (Act 2). At this time, the mobile telephone terminal 2 is held over the wireless communication section 34 of the POS terminal 3 by, for example, a customer and is adjacent thereto. At this time, in this embodiment, it is assumed that in the display section 12 of the mobile telephone terminal 2, for example, as shown in FIG. 5, a normal screen of a mail formation screen is displayed.

In the IC card section 15 of the mobile telephone terminal 2, when the card communication section 15c receives the billing information from the POS terminal 3 (Act 11), the card control section 15a performs a subtraction process to subtract the billing amount contained in the billing information from the balance of the electronic money stored in the card storage section 15b (Act 12). After this subtraction process is executed, the card control section 15a transmits the payment information, which includes customer identification information and information indicating that the subtraction process is completed, to the POS terminal 3 by the card communication section 15c (Act 13). Next, the control section 10 of the mobile telephone terminal 2 operates as the request unit 18, displays holding request information on the display section 12, and requests the user of the mobile telephone terminal 2 to continue to hold the mobile telephone terminal 2 over the POS terminal 3 (particularly the wireless communication section 34) until the completion of the electronic settlement is notified (Act 13a). The holding request information is, for example, a message of “Please continue to hold the mobile telephone terminal 2 over the POS terminal 3 until the completion of the electronic settlement is notified”. The holding request information is, for example, pop-up displayed on the display section 12.

The control section 30 (settlement unit 36) of the POS terminal 3 receives the payment information from the mobile telephone terminal 2 and completes the electronic settlement (Act 3). When completing the electronic settlement, the control section 30 operates as the accounting information transmission unit, generates accounting information (Act 4), and transmits the accounting information to the mobile telephone terminal 2 by controlling the wireless communication section 34 (Act 5). That is, when the accounting information is transmitted from the POS terminal 3 to the mobile telephone terminal 2, the operation of the user of the mobile telephone terminal is unnecessary. The accounting information includes the store name, sales data, total amount, transaction date and time, amount received as the payment amount in the electronic settlement (electronic money), and the like. Incidentally, the store name is previously stored in the storage section 33.

When receiving the accounting information transmitted from the POS terminal 3 (Act 14), the IC card section 15 of the mobile telephone terminal 2 transmits reception completion information indicating reception of the accounting information to the POS terminal 3 (Act 15). Particularly, after the card communication section 15c receives the accounting information, the IC card section 15 operates as the transmission unit 15d, and transmits the reception completion information indicating the reception of the accounting information to the POS terminal 3. The IC card section 15 outputs the received accounting information to the control section 10. When the accounting information is inputted from the IC card section 15, the control section 10 of the mobile telephone terminal 2 functions as the information storage unit 19, and stores the inputted accounting information in the storage section 11 of the mobile telephone terminal 2 (Act 15a). Then, the control section 10 of the mobile telephone terminal 2 deletes the holding request information from the display section 12.

On the other hand, in the POS terminal 3 receiving the reception completion information from the mobile telephone terminal 2, the CPU of the control section 30 operates as the notification unit 37, and the speaker as the notification device outputs a sound indicating settlement completion (Act 6). Incidentally, the notification device to notify the settlement completion is not limited to the speaker, and, for example, a buzzer may be used, or a display device to display the settlement completion may be used.

In the mobile telephone terminal 2, after the transmission unit 15d transmits the reception completion information to the POS terminal at Act 15, the control section 10 operates as the display unit 17, starts clocking (Act 15b), and displays the receipt display 50 (FIG. 6) indicating the accounting information on the display section 12 (Act 16). In this embodiment, the control section 10 pop-up displays the receipt display 50. In this display process, the control section 10 reads image data of receipt format stored in the ROM of the control section 10 and expands it in the VRAM. Further, the control section incorporates the accounting information in the expanded image data of the receipt format, and generates the image data of the receipt display 50. The control section 10 transmits the generated image data of the receipt display 50 to the display section 12, and displays the receipt display 50 on the display section. As shown in FIG. 6, the store name, transaction date and time, name and unit price of the commodity as sales data, total amount, amount received, electronic money balance and the like are displayed in the receipt display 50.

The display unit 17 displays the receipt display 50 for a specified time from the start of clocking (No at Act 16a). Although the specified time is preferably a short time such as, for example, 10 seconds, 30 seconds or 60 seconds, the time may exceed 60 seconds. When the specified time passes after clocking starts (that is, after the receipt display 50 is displayed on the display section 12) (Yes at Act 16a), the control section 10 erases the receipt display 50 (Act 17). By this, as shown in FIG. 5, the screen of the display section 12 of the mobile telephone terminal 2 returns to the normal screen. By these Acts 15a to Act 17, the function of the display unit 17 is performed in which the receipt display 50 indicating the accounting information is displayed on the display section 12 for the specified time, and when the specified time passes, the receipt display 50 is erased. Even if the receipt display 50 is erased, the accounting information stored in the storage section 11 is held as it is.

As described above, in this embodiment, in the mobile telephone terminal 2, the display unit 17 displays the receipt display (electronic receipt) 50 indicating the accounting information on the display section 12 for the specified time, and when the specified time passes, the receipt display 50 is erased. Accordingly, since the receipt display 50 is automatically displayed, the customer is not required to inquire of the server about the information unlike the related art, and the customer can easily see the accounting information by the mobile telephone terminal 2. Besides, in this embodiment, when the specified time passes, the receipt display 50 is automatically erased. Thus, the customer is not required to perform an operation to erase the receipt display 50, and is comfortable.

Besides, in this embodiment, the IC card section 15 as the payment unit performs data communication with the POS terminal 3 as the settlement apparatus by the card communication section 15c as the communication section, and performs the electronic settlement of the transaction to the POS terminal 3. The card communication section 15c receives the accounting information from the POS terminal 3 in the electronic settlement. Accordingly, when the electronic settlement of the transaction is performed, the card communication section 15c receives the accounting information, and the accounting information is automatically displayed by the display unit 17. Thus, the customer can easily see the accounting information without performing a specific operation.

Besides, in this embodiment, since the display unit 17 pop-up displays the receipt display 50, there is a merit that the customer can easily recognize the receipt display 50.

Besides, in this embodiment, the storage section 11 stores the accounting information. Thus, even if the receipt display 50 is erased by the display unit 17, since the accounting information corresponding to the receipt display remains in the storage section 11, the accounting information can be confirmed when necessary.

Incidentally, the invention is not limited to the above embodiment, and other various embodiments can be adopted. For example, in the above embodiment, although various programs are stored in the ROM and the storage sections 11 and 33, no limitation is made to this. The program executed in the above embodiment may be provided by being stored on a computer readable storage medium, such as a CD-ROM, a flexible disk (FD), a CD-R or a DVD, as a file of an installable format or an executable format. Besides, the program executed in the above embodiment is stored in a computer connected to a network such as the Internet, and may be provided by being downloaded via the network. Besides, the program executed in the above embodiment may be provided or distributed via the network such as the Internet.

Besides, in the embodiment, although the description is made while using the example in which the mobile terminal is the mobile telephone terminal 2 having the telephone communication section, no limitation is made to this. The mobile terminal may not be provided with the telephone communication section.

Besides, in the embodiment, although the description is made while using the example in which the settlement apparatus is applied to the POS terminal 3, no limitation is made to this. The settlement apparatus may be applied to an ECR (Electric Cash Register) or a self checkout apparatus operated by the customer.

Besides, in the embodiment, although the description is made while using the example in which the electronic money is of the prepaid type, the electronic money may be of a postpaid type. In this case, the electronic settlement information includes at least customer identification information. In this case, the process of Act 12 in FIG. 4 is omitted, and the POS terminal 3 receiving the payment information including the customer identification information at Act 3 transmits billing information, in which the customer identification information and the amount billed are correlated, at a predetermined timing to a server (not shown) of an enterprise which provides the electronic money service of the postpaid system.

As described above, in the mobile terminal, the settlement apparatus and the display method according to the embodiment, there is an effect that the customer can easily see the accounting information by the mobile terminal.

While certain embodiments have been described, these embodiments have been presented by way of example only, and are not intended to limit the scope of the inventions. Indeed, the novel terminal, apparatus and method described herein may be embodied in a variety of other forms; furthermore, various omissions, substitutions and changes in the form of the terminal, apparatus and method described herein may be made without departing from the spirit of the inventions. The accompanying claims and their equivalents are intended to cover such forms or modifications as would fall within the scope and spirit of the inventions.

What is claimed is:

1. A mobile terminal comprising:
a communication section to receive accounting information from a settlement apparatus to transmit the accounting information relating to a transaction;
a display section; and
a display unit configured to display a receipt display indicating the accounting information on the display section for a specified time, and to erase the receipt display when the specified time passes.

2. The terminal of claim 1, further comprising a payment unit configured to perform data communication with the settlement apparatus by the communication section and to perform an electronic settlement of the transaction to the settlement apparatus, wherein
the communication section receives the accounting information from the settlement apparatus in the electronic settlement.

3. The terminal of claim 1, wherein the display unit pop-up displays the receipt display.

4. The terminal of claim 1, further comprising a storage section to store the accounting information.

5. The terminal of claim 1, further comprising a transmission unit configured to transmit reception completion information indicating reception of the accounting information to the settlement apparatus after the communication section receives the accounting information, wherein
the display unit displays the receipt display after the transmission unit transmits the accounting information to the settlement apparatus.

6. The terminal of claim 2, further comprising a request unit configured to request that the mobile terminal is held over the settlement apparatus until completion of the electronic settlement is notified, wherein
the communication section performs wireless communication with the settlement terminal.

7. A settlement apparatus comprising:
settlement means for performing data communication with a mobile terminal and performing an electronic settlement of a transaction to the mobile terminal;
accounting information transmission means for transmitting accounting information relating to the electronic settlement to the mobile terminal after the electronic settlement is completed; and
notification means for notifying completion of the electronic settlement after receiving reception completion information, which indicates reception of the accounting information, from the mobile terminal.

8. A display method executed in a mobile terminal including a communication section to receive accounting information from a settlement apparatus to transmit the accounting information of a transaction, and a display section, the display method comprising:
displaying, by a display unit, a receipt display indicating the accounting information on the display section for a specified time, and erasing the receipt display when the specified time passes.

9. The method of claim 8, further comprising performing, by a payment unit, an electronic settlement of the transaction to the settlement apparatus by performing data communication with the settlement apparatus by the communication section, wherein
the communication section receives the accounting information from the settlement apparatus in the electronic settlement.

10. The method of claim 8, wherein the display unit pop-up displays the receipt display.

11. The method of claim 8, further comprising storing, by a storage unit, the accounting information in a storage section of the mobile terminal.

12. The method of claim 8, further comprising:
transmitting, by a transmission unit, reception completion information indicating reception of the accounting information to the settlement apparatus after the communication section receives the accounting information, wherein
the display unit displays the receipt display after the transmission unit transmits the accounting information to the settlement apparatus.

13. The method of claim 8, further comprising requesting, by a request unit, that the mobile terminal is held over the settlement apparatus until completion of the electronic settlement is notified, wherein
the communication section performs wireless communication with the settlement terminal.
